(19) United States
(12) Patent Application Publication
(10) Pub. No.: US 2014/0146587 A1
(43) Pub. Date: May 29, 2014

(54) POWER MODULE WITH A MULTI-RESONANCE CIRCUIT (EMBODIMENTS)

(71) Applicants: Igor Pavlovich Voronin, Moscow (RU); Pavel Anatolievich Voronin, Moscow (RU)

(72) Inventors: Igor Pavlovich Voronin, Moscow (RU); Pavel Anatolievich Voronin, Moscow (RU)

(21) Appl. No.: 14/113,386

(22) PCT Filed: Apr. 24, 2012
(86) PCT No.: PCT/RU2012/000313

§ 371 Date: Dec. 24, 2013

(30) Foreign Application Priority Data
Apr. 24, 2011 (RU) 2011116247

(51) Int. Cl. H02M 7/537

(52) U.S. Cl. CPC H02M 7/537
USPC 363/131

(57) ABSTRACT

The invention relates to power electronics. The use of said invention in autonomous inverter and pulse regulator circuits makes it possible to reduce dynamic losses and additional losses of conductivity in mains switches and to prevent high-frequency interference during switching of said switches. The power module has a positive, a negative and an output power terminal and comprises a first and a second switch, each having an antiparallel diode of the same type, and an LC series circuit. The technical result is achieved by the introduction of a capacitor, the first and second plates of which are respectively connected to the output power terminal of the module and to the positive or negative power terminal of the module.

### EMBODIMENTS

This invention relates to power electronics and more particularly to converters with low dynamic losses in power semiconductor switches and can be used in designs of autonomous inverters and pulsed controllers.

A converter design is known which provides for a mild disconnecting of the main transistors at zero current with the help of two additional switches and of a LC-circuit connected in series (U.S. Pat. No 5,486,752 published on Jan. 23, 1996).

A drawback of the above mentioned solution resides in the fact that the connection of the main transistors remains rigid which considerably increases dynamic losses in the circuit.

The most close to the technical essence of the claimed invention is a solution (U.S. Pat. No 6,172,882, published on Jan. 9, 2001) comprising a power module comprising two switches with diodes connected in the opposite direction and in parallel, and a LC-circuit, connected in the way that the output of the first switch connected to the cathode of the diode connected in the opposite direction and in parallel is connected to the negative power terminal of the module, the first output of the series LC circuit being connected to the point of juncture of the switches and its second output being connected to the power output terminal of the module.

The above disclosed solution provides for a mild turning on of the main switches of the converter at zero voltage and their mild turning off at zero current, which considerably reduces the power of dynamic losses. Nevertheless, the mild turning on of the main switches at zero voltage is based on the use of inertia properties of their antiphase diodes and it is not stable at load current increase. In this case, the rate of voltage change at the main switches is rather high, which leads to additional power losses at the stages of dynamic saturation and of residual current. One more drawback of the above disclosed design resides in high-frequency noise arising while switching the main switches.

The technical effect of the device according to the claimed invention resides in the following:

1. The condition of a mild switching of the main switches at changes of the load current is provided by a new established criterion.

2. The reduction of dynamic losses in the main switches is provided at the stages of fixing, by a relatively slow modification of the voltage edge at these switches thanks to the connection of an additional capacitor.

3. The reduction of additional conductivity losses in the main switches is provided thanks to the decrease of the current amplitude in the reverse diodes of these switches at the stage of their mild turning off while using an additional capacitor.

4. The elimination of high-frequency noise while switching the main switches is provided by the reduction of the resonance frequency of the oscillation process between the output capacitors of these transistors and the elements of the multi-resonance circuit at the connection of an additional capacitor.

This technical effect is obtained thanks to the fact that into a power module comprising the first and the second switches, each of them having a similar antiparallel diode, and a series LC-circuit, the output of the first switch connected to the cathode of the first antiparallel diode being connected to the module positive power terminal, and the output of the second switch, joined to the anode of the second antiparallel diode being connected to the negative module power terminal, the first output of the series LC-circuit being connected to the point of juncture of the first and the second switches, the second output of which being connected to the module power output terminal, according to the first object of the claimed invention, a capacitor is inserted, the first and the second plates of which are joined, respectively, to the module power output terminal and to the module power positive terminal.

The same technical effect is obtained thanks to the fact that into the power module comprising the first and the second switches, each of them having a similar antiparallel diode, and a series LC-circuit, the output of the first switch connected to the cathode of the first antiparallel diode being connected to the module positive power terminal, and the output of the second switch, joined to the anode of the second antiparallel diode being connected to the negative module power terminal, the first output of the series LC-circuit being connected to the point of juncture of the first and the second switches, the second output of which being connected to the module power output terminal, according to the first object of the claimed invention, a capacitor is inserted, the first and the second plates of which are joined, respectively, to the module power output terminal and to the module power negative terminal.

The invention is illustrated by accompanying drawings in which the same elements are identified by the same reference numbers.

FIG. 1 illustrates a power module with a multi-resonance circuit according to the first embodiment.

FIG. 2 illustrates a power module with a multi-resonance circuit according to the second embodiment.

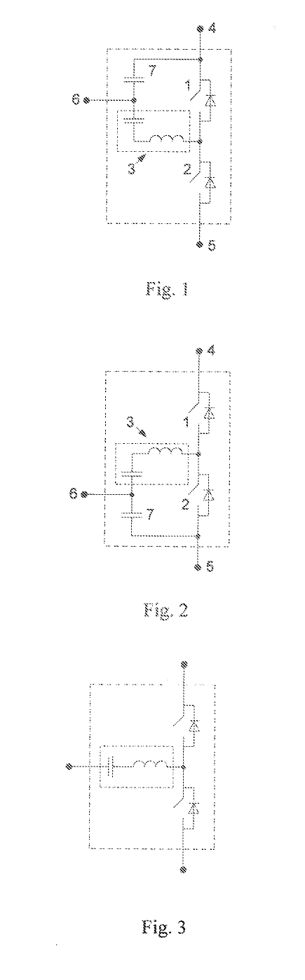

FIG. 3 illustrates a diagram of the closest analogous device.

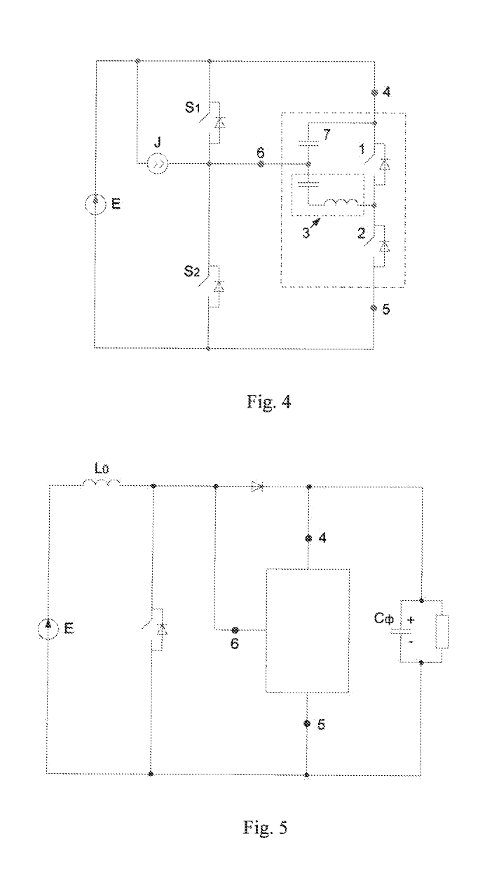

FIG. 4 illustrates a power module with a multi-resonance circuit, connected to the main switching circuit of a converter.

FIG. 5 illustrates a power module with a multi-resonance circuit, connected to a constant voltage converter (a pulsed regulator, step-up type).

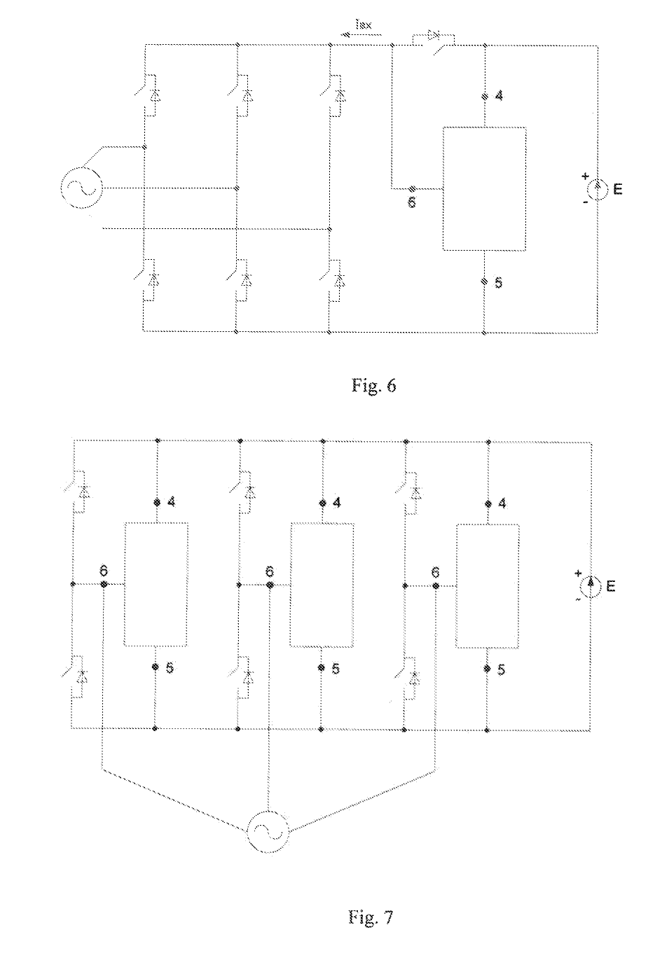

FIG. 6 illustrates a power module with a multi-resonance circuit, connected to a voltage inverter at the direct current side.

FIG. 7 illustrates a power module with a multi-resonance circuit, connected to a voltage inverter at the alternating current side.

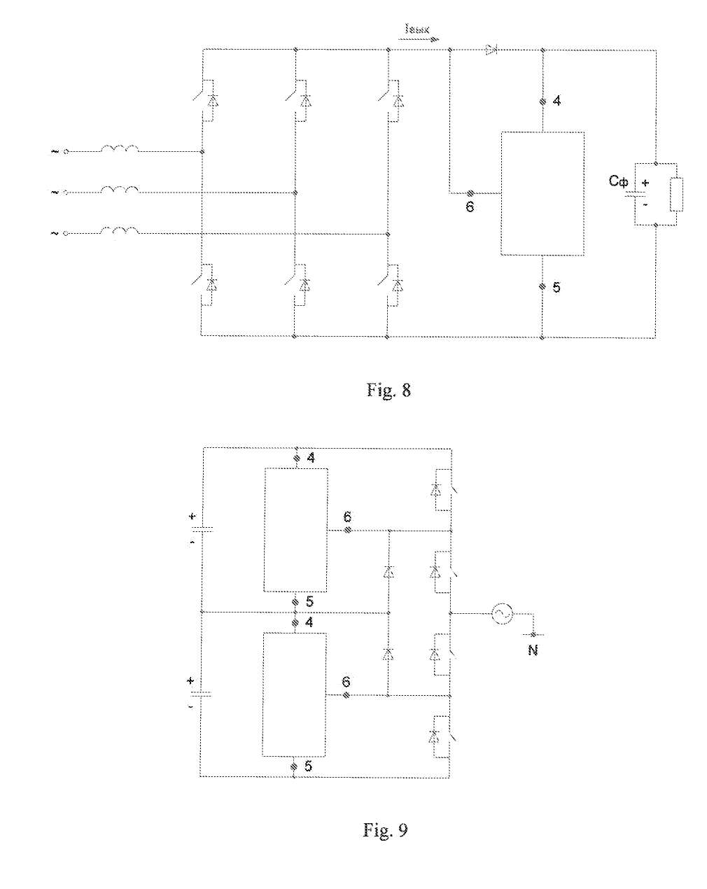

FIG. 8 illustrates a power module with a multi-resonance circuit, connected to an active rectifier at the direct current side.

FIG. 9 illustrates a power module with a multi-resonance circuit, connected to a three-level voltage inverter.

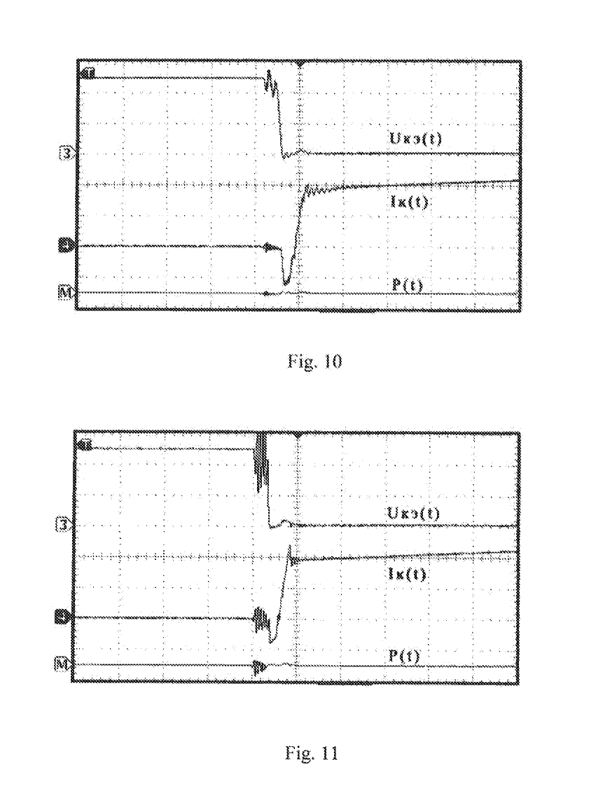

FIG. 10 illustrates an oscillogram of the mild turning on for one of the main switches of the converter while using a power module with a multi-resonance circuit according to the present invention.

FIG. 11 illustrates an oscillogram of the mild turning on for one of the main switches of the converter in the absence of a capacitor.

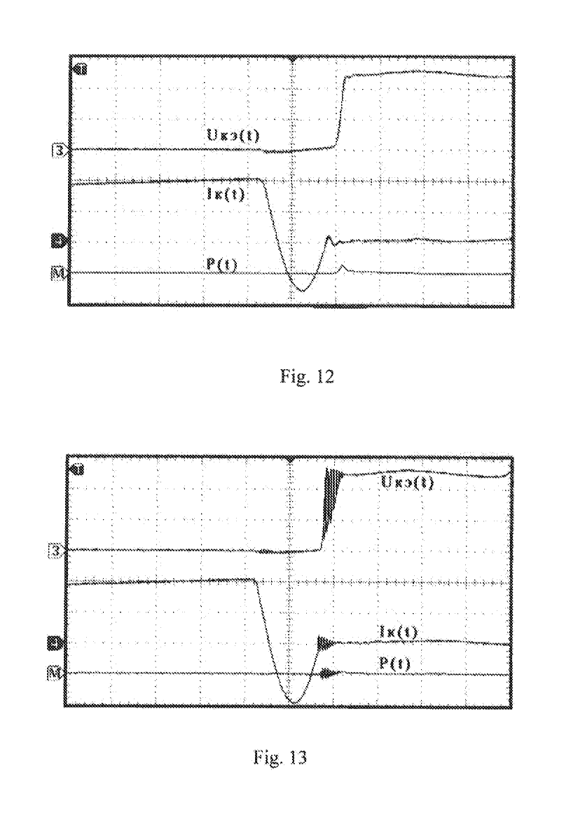

FIG. 12 illustrates an oscillogram of the mild turning off for one of the main switches of the converter while using a power module with a multi-resonance circuit according to the present invention.

FIG. 13 illustrates an oscillogram of the mild turning off for one of the main switches of the converter in the absence of a capacitor.

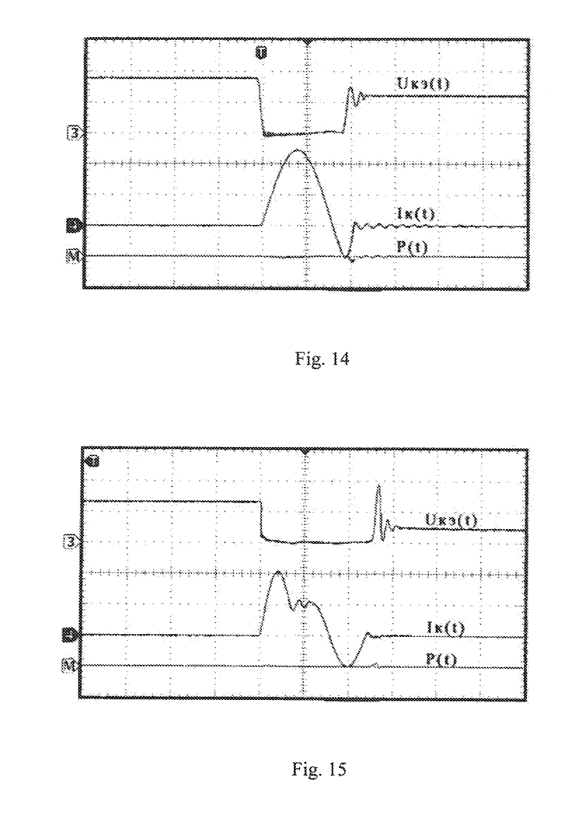

FIG. 14 illustrates an oscillogram of the mild switching for the switch 1 of the power module with a multi-resonance circuit according to the present invention.

FIG. 15 illustrates an oscillogram of the mild switching for the switch 2 of the power module with a multi-resonance circuit according to the present invention.

The power module (FIG. 1) contains: the first switch 1 and the second switch 2, each of them having a similar antiparallel diode, a series LC-circuit 3, a positive power terminal 4, a negative power terminal 5, a power output terminal 6 and a capacitor 7.

The output of the switch 1 joined to the cathode of the first antiparallel diode is connected to the positive power terminal 4, and the output of the second switch 2 joined to the anode of the second antiparallel diode is connected to the negative power terminal 5. To the point of juncture of the first and the second switches 1, 2, the first output of the series LC-circuit 3 is connected, the second output of which is connected to the power output terminal 6. The first plate of the capacitor 7 is joined to the positive power terminal 6 and the second plate of the capacitor 7 is joined to the positive power terminal 4. The second plate of the capacitor 7, as depicted in FIG. 2, can be connected as well to the negative power terminal 5.

The device according to the claimed invention operates as follows.

Any electric energy converter represents a device receiving energy from a power supply and transferring the energy to a load. Therewith, the energy transfer from the input to the output should involve a possibility to control the energy flux.

The combination of a minimal set of elements forming a circuit to solve a problem of control is considered as the basic switching model of a converter. It is known that two switches, a choke (a power supply) and a capacitor (a voltage source) form a minimal set necessary for any basic control system.

Let's examine the operation of a power module with a multi-resonance circuit when it is connected to a basic switching circuit of a converter (FIG. 4).

Let's suppose that a current source J is joined to the point of juncture of the main switches S1 and S2 of the converter. When the second main switch S2 is turned off, said J current flows via an antiparallel diode of the first main switch S1 which is in antiphase relative to the second main switch S2.

Then the output capacitor of the main switch S2 is charged to the voltage of the power supply E and the output capacitor of the antiphase (first) main switch S1 is completely discharged. In this case, the capacitor 7 is discharged to zero as well.

Let's consider the initial voltage on the capacitor of the LC-circuit 3 equal to U, with the polarity shown in the diagram. The absolute value of the voltage U₀₊ will be determined below, at one of the intervals of the commutation period.

Before turning on the first main switch (a transistor) S2, the first switch 1 is turned on.

1. Interval of the Capacitor Recharging in the LC-Circuit.

Via the open first switch 1 and the antiparallel diode of the first main switch S1, due to an oscillation process, the capacitor in the L-circuit is recharged to the initial voltage U₀₊, but with opposite polarity. The time of this recharging is equal to the half period of the resonance frequency in the LC-circuit:

Δt₁=π\sqrt{LₖCₖ}; (1)

where Lₖ is the inductance of the choke in the LC-circuit; Cₖ is the capacitance of the capacitor in the LC-circuit.

After the time interval Δt1, the current of the choke in the LC-circuit will flow via the antiparallel diode of the first switch 1, when the control signal from this switch can be taken off.

2. Commutation Interval of the Antiparallel Diode of the First Main Switch S1.

After recharging the capacitor, the current of the choke in the LC-circuit starts increasing in a counter flow to the current of the antiparallel diode of the first main switch S1, and when the initial current J is reached, this diode is cut off. The time of the commutation interval Δt2 is determined by the equation:

Δt₂=\sqrt{LₖCₖ}arcsin(ρₖJ/U₀₊); (2)

where ρₖ=\sqrt{LₖCₖ} is the wave impedance of the series LC-circuit.

At the end of the commutation interval, the voltage at the capacitor Cₖ in the LC-circuit becomes equal to U₀, which is determined by the equation:

U₀=\sqrt{U₀₊²−(Jρₖ)²}. (3)

3. Interval of the Resonance Discharging of the Output Capacity of the Second Main Switch S2.

The output capacity C_{T} of the second main switch S2 is determined by the capacity C_{X} of the capacitor 7, which is selected to be much higher than the own output capacity of the second main switch S2:

C_{T}=C_{X}. (4)

After cutting off the antiparallel diode of the first main switch S1, a parallel resonance circuit is formed in the diagram, which comprises the power supply J, the capacitor C_{X}, as well as the choke in the LC-circuit with a series equivalent voltage source:

$$\text{?} = E - {u}_{Ck} ( t ) ; \\ \text{?} \text{indicates text missing or illegible when filed} \qquad ( 5 )$$

where u_{Ck}(t) is the voltage on the capacitor in the LC-circuit.

Therewith, the voltage at the second main switch S2 will change according to the equation:

$${u}_{S 2} ( t ) = E - {U}_{0} ( 1 - cos ( {ω}_{0} t ) ) + \frac{J}{{C}_{k}} t ; \qquad ( 6 )$$

where ω₀=1/\sqrt{LₖCₖ} is the circular frequency of the resonance process before turning on the second main switch S2.

In this case, the voltage on the capacitor in the LC-circuit will be:

$${u}_{Ck} ( t ) = {U}_{0} - {U}_{0} \frac{{C}_{x}}{{C}_{k}} ( 1 - cos ( {ω}_{0} t ) ) - \frac{J}{{C}_{k}} t . \qquad ( 7 )$$

The equation (6) implies a condition when, as a result of the resonance, zero voltage is established on the second main switch S2:

$${U}_{0} \geq \frac{E}{2} ( 1 + \frac{{C}_{x}}{{C}_{k}} ) + π \sqrt{{L}_{k} {C}_{x}} \frac{J}{2 {C}_{k}} . \qquad ( 8 )$$

Thus, the condition of zero voltage on the second main switch S2 is determined by the voltage value on the capacitor in the series LC-circuit at the moment of commutation of the antiparallel diode in the first switch S1 for the given parameters of the electrical mode of operation of the circuit (E and J) and for the selected parameters of the multi-resonance circuit (Lₖ, Cₖ and C_{X}).

The duration Δt3 of the resonance interval is determined from the equation (6) for u_{S2} (t)=0:

Δt₃=\sqrt{LₖCₓ}arccos(1−E/U₀). (9)

After the interval Δt3, the second main switch S2 can be turned on at zero voltage.

4. Interval of Energy Release from the Commutation Choke in the LC-Circuit.

The voltage on the capacitor in the LC-circuit after discharging the output capacity of the second main switch S2 becomes equal to:

$${U}_{*} = {U}_{0} - E \frac{{C}_{x}}{{C}_{k}} - J \frac{{C}_{x} + {C}_{k}}{{C}_{k}^{2}} Δ {t}_{3} . \qquad ( 10 )$$

The current in the choke of the LC-circuit after discharging the output capacity of the second main switch S2 becomes equal to:

I_{*} =J+(U₀/ρ₀)sin(ω₀Δt₃); (11)

where ρ₀\sqrt{Lₖ/Cₓ} is the wave impedance of the multi-resonance circuit after turning on the second main switch S2.

After turning on the second main switch S2, the series LC-circuit becomes connected, via the antiparallel diode of the first switch 1, to the power supply of the circuit. Solving the equation of the oscillation process in the LC-circuit without losses, we get for the current value in the choke of the LC-circuit:

i_{Lk}(t)=\sqrt{I_{*} ²+[(E−U_{*} )/ρₖ]²}cos(ωₖt+β); (12)

where β=arctg[(E−U_{*})/(ρₖI_{*})].

Integrating (12) with respect to time, we obtain respectively for the voltage on the capacitor Cₖ:

u_{Ck}(t)=E−\sqrt{(ρₖI_{*} )²+(E−U_{*})²}sin(ωₖt+β). (13)

The difference of the current J and of the current in the choke of the LC-circuit flows first via the antiparallel diode of the second main switch S2 and then via the same second main switch S2.

When the current on the transistor of the second main switch S2 reaches the current value J, the current on the choke of the LC-circuit becomes equal to zero.

Equating (12) to zero value for the interval of energy release Δt4, we obtain:

Δt₄=\sqrt{LₖCₖ}(π/2−β). (14)

In this case, the voltage on the capacitor in the LC-circuit becomes equal to:

U₀₋=E−\sqrt{(ρₖI_{*})²+(E−U_{*} )²}; (15)

where U₀₋=u_{Ck}(Δt₄).

The voltage on the capacitor in the LC-circuit, equal to U₀₋ and having the polarity opposite to that of the initial voltage U₀₊, can be further used for a mild turning off of the second main switch S2 at zero current.

5. Conductance Range for the Load Current.

The time interval Δt5 is determined by the duration of the open state of the second main switch S2.

6. Interval of Resonance Turning Off of the Second Main Switch S2.

Before turning off the second main switch S2, a control signal is sent to the second switch 2, and the current i_{Lk}(t) of the oscillation LC-circuit starts increasing in a counter flow to the current J flowing via the open second main switch S2:

i_{Lk}(t)=(U₀₋/ρₖ)sin(ωₖt). (16)

In this case, the voltage on the capacitor in the LC-circuit will change according to the law:

u_{Ck}(t)=U₀₋cos(ωₖt) (17)

Since the second main switch S3 is in the open state, the voltage on the capacitor 7 will remain unchanged. Then the circular frequency of the resonance process, at turning off the second switch S2, will be determined by the frequency ωₖ of the series LC-circuit, which is different from the resonance frequency ω0.

Thus, the oscillation circuit in the power module, composed of a series LC-circuit 3 and a capacitor 7 is multi-resonant, since it has different resonance frequencies when turning on and turning off the first and the second mains switches S1, S2 of the converter.

Turning off of the second main switch S2 at zero current is possible only when satisfying the condition:

U₀₋≧ρₖJ. (18)

At the moment of the current equality in the LC-circuit and of the current J, the antiparallel diode of the second main switch S2 is turned on, through which the difference of said currents flows further. It is obvious that the control signal from the second main switch S2 should be taken off before occurring a new equality of said currents. After that, the reverse (antiparallel) diode is cut off, and the considered interval of the mild commutation is ended.

The duration Δt6 of the interval is determined by the equation (16) for the given current J:

Δt₆=\sqrt{LₖCₖ}(π/2+arccos(ρₖJ/U₀₋)). (19)

At the moment of time when the current in the LC-circuit reaches the maximum value, the voltage on the capacitor in the LC-circuit will change its polarity and then grows to the value Ux. This voltage is determined from the equation (17) wile substituting there the time interval Δt6:

Uₓ=\sqrt{(U₀₋)²−(ρₖJ)²}. (20)

The voltage Ux depends on the current J, but it will be always lower than the initial voltage equal to U₀₊. To provide stability of the cycles of mild switching, it is necessary to increase the level of voltage on the capacitor in the LC-circuit up to the initial value U₀₊. For this purpose, after turning off the second main switch S2 and cutting off its reverse (antiparallel) diode, the second switch 2 is left in the open state.

7. Recharge Interval of the Capacitor in the LC-Circuit Up to the Voltage of the Power Supply.

Since the voltage Ux on the capacitor CK is lower than the supply voltage E, the antiphase (antiparallel) diode of the first main switch S1 will be in the closed state at the beginning of the interval. Thus, the only way to flow for the current J is via the series LC-circuit and the open second switch 2. In this case, the current J will charge the capacitor CK practically in a linear way:

$${u}_{Ck} ( t ) = {U}_{x} + \frac{J}{{C}_{k}} t . \qquad ( 21 )$$

The duration of the interval Δt7 of recharge is determined from the equation (21) at the voltage E on the capacitor:

$$Δ {t}_{7} = \frac{( E - {U}_{x} ) {C}_{k}}{J} . \qquad ( 22 )$$

8. Interval for the Resonance Recovery of the Initial Voltage on the Capacitor in the LC-Circuit.

When the voltage on the capacitor in the LC-circuit increases up to the voltage E, the antiparallel diode of the first main switch S1 is open. Via said diode, the series LC-circuit is connected to the power supply, and one more resonance process starts in it with the circular frequency ωₖ. The current in the choke and the voltage on the capacitor in the LC-circuit are described in this case by a system of equations:

$$\{ \begin{matrix}{i}_{l , k} ( t ) = J cos ( {ω}_{k} t ) \\ {u}_{Ck} ( t ) = E + {ρ}_{k} J sin ( {ω}_{k} t )\end{matrix} \qquad ( 23 )$$

After one forth of the oscillation process period, the choke current flows to the antiparallel diode of the second switch 2.

After a half period more, this antiparallel diode is automatically cut off, the choke current in the LC-circuit reducing to zero. Thus, the whole duration of the interval Δt8 is three quarters of a resonance period equal to 2π\sqrt{LₖCₖ}:

$$Δ {t}_{8} = \frac{3}{2} π \sqrt{{L}_{k} {C}_{k}} . \qquad ( 24 )$$

Substituting Δt8 in the equation (23) for the voltage on the capacitor in the LC-circuit, we get at the end of the interval:

u_{Ck}(Δt₈)=E−ρₖJ=U₀₊. (25)

Thus, one can consider that the whole cycle of one commutation period is completed. And, starting from the voltage U₀₊, one can start a new time step.

After determining the analytical form of the initial voltage U₀₊, the voltage on the capacitor in the LC-circuit at the moment of commutating the antiphase (antiparallel) diod of the first main switch S1, which is designed as U₀, could be expressed under a different form. For this, substituting U₀₊ from (25) for the formula (3), one gets:

U₀=\sqrt{E(E−2ρₖJ)}. (26)

Then the formula (8) for the criterion of turning on the second main switch S2, at zero voltage, is transformed to the form where are comprised only the parameters specifying the electrical mode of the circuit and the parameters of the multi-resonance circuit:

$$\sqrt{1 - \frac{2 J}{E / {ρ}_{k}}} \geq \frac{1}{2} ( 1 + \frac{{C}_{x}}{{C}_{k}} ) + \frac{π}{2} \frac{J}{E / {ρ}_{k}} \sqrt{\frac{{C}_{x}}{{C}_{k}}} . \qquad ( 27 )$$

Let's introduce the parameter χ, that is named the load factor of the diagram:

$$χ = \frac{{ρ}_{k} J}{E} . \qquad ( 28 )$$

In reality, the parameter χ is equal to the current J ratio to the maximal current of the first and the second switches 1 and 2.

Let's insert as well the parameter q, that is named the factor of relationship on resonance frequencies in the multi-resonance circuit at the second main switch S2 turned off, at zero current and at turning on the second main switch S2 at zero voltage:

$$q = \frac{{f}_{pHT}}{{f}_{pHH}} = \sqrt{\frac{{C}_{x}}{{C}_{k}}} . \qquad ( 29 )$$

Let's rewrite the inequality (26) with regard to the factors inserted:

$$\sqrt{1 - 2 χ} \geq \frac{1}{2} ( 1 + {q}^{2} ) + \frac{π}{2} χ q . \qquad ( 30 )$$

As we note, when the inequality (30) is realized, the criterion of mild turning off at zero current is automatically realized according to the equation (18). As to the present boundary mode, these equations are in an identical equality.

Thus, the inequality (30) represents a newly established criterion for a mild commutation of the main switches of the converter which, in contrast to the closest analogous devices, does not depend on the inertia properties for the diodes used in the circuit.

Higher is the current j, more difficult is to satisfy the criteria for a mild commutation. That is why the rated values for the elements of the multi-resonance circuit satisfying the above mentioned limitations should be selected for the maximal load current. For all the other values of the current J, lower than the maximal ones, the conditions of a mild commutation for the main switches will be met automatically.

Dynamical processes occurring in the first and the second switches 1 and 2 of the considered device are of a mild character, since the current variation in the same is determined by a smooth variation of current in the oscillation LC-circuit. The first and the second switches 1 and 2 do not show any preliminary discharging of their output capacitors before turning them on, which generally leads to additional losses. Nevertheless, since the operation of these switches occurs within relatively short time intervals, devices are used the average current value of which is lower than for the main switches. For this reason as well, the output capacitors of the first and second switches 1 and 2 are considerably lower than for the first and the second main switches S1 and S2.

The application of a capacitor 7 leads to a higher discharge of the capacitor in the LC-circuit 3 while turning on the main switch. On the one hand, it complicates somewhat the fulfillment of the criterion of a mild commutation. On the other hand, it enables to reduce additional losses of conductance in the main switches, since the current amplitudes in the reverse diodes of the main switches are simultaneously reduced at the stages of their mild turning off.

When the direction of the current J changes, id. e. when it flows from the point of juncture of the first and the second main switches S1 and S2, at the first main switch S1 turned off, this current will flow via the antiparallel diode of the second main switch S2. Similarly to the above described stages of a mild commutation of the second main switch, one can carry out a mild commutation of the load current before commuting the first main switch S1. For this purpose, before turning on the first main switch S1, the second main switch S2 is unlocked. Then in the claimed device, there take place processes that are symmetric to the above described and that provide for the turning on the first main switch S1 at zero voltage. Further, before turning off the first main switch S1, the first switch 1 is turned on, which provides conditions for turning off the first main switch S1 at zero current.

The second plate of the capacitor 7 can be joined as well to the negative power terminal 5. Since the output capacity of the second main switch S2 remains unchanged in this case, the electrical processes in the circuit will remain unchanged, compared to a solution where the second plate of the capacitor is connected to the positive power terminal 4.

The operation principle of the device and the criteria of a mild commutation do not change while using various kinds of switches (bipolar and field-effect transistors as well as thyristors and insulated-gate bipolar transistors IGBT).

Let's examine further some embodiments of application for the device according to the claimed invention.

FIG. 5 illustrates a power module with a multi-resonance circuit according to the present invention, connected to a constant voltage converter (a pulsed regulator of a step-up type).

The mild commutation in the present converter means that the positive and negative power terminals of the module are connected respectively to the positive and negative poles of the constant voltage supply in the converter, the function of which is provided by a capacitor C_{φ} of an output filter, the output power terminal being connected to the pole of the direct current power supply in the converter, the function of which is provided by a choke at the input L0.

FIG. 6 illustrates a power module with a multi-resonance circuit according to the present invention, connected to a voltage inverter at the side of direct current.

The mild commutation according to the present invention resides in the fact that the positive and negative power terminals of the module are connected respectively to the positive and negative poles of the constant voltage supply in the converter, the function of which is provided by a voltage source E of the inverter, and the output power terminal is connected to a pole of the direct current power supply in the converter, the function of which is provided by the input current of the inverter.

FIG. 7 illustrates a power module with a multi-resonance circuit according to the present invention, connected to a voltage inverter at the side of alternating current.

In the present case, the number of auxiliary power modules with a multi-resonance circuit is as high as three, in accordance with the number of the inverter phases. The mild commutation in this converter resides in the fact that the positive and negative power terminals of the three modules are connected respectively to the positive and negative poles of the constant voltage supply in the converter, the function of which is provided by a voltage source E of the inverter, and the output power terminals of the modules are connected to respective poles of the alternating current power supply in the converter, the function of which is provided by the phase currents of the inverter.

FIG. 8 illustrates a power module with a multi-resonance circuit according to the present invention, connected to an active rectifier at the side of direct current.

The mild commutation in the present converter resides in the fact that the positive and negative power terminals of the module are connected respectively to the positive and negative poles of the constant voltage supply in the converter, the function of which is provided by a capacitor C_{φ} of an output filter in the rectifier, and the output power terminal of the module is connected to a pole of the direct current power supply in the converter, the function of which is provided by the output current of the active rectifier.

FIG. 9 illustrates a power module with a multi-resonance circuit according to the present invention, connected to a three-level voltage inverter.

The connection to one phase of the three-level inverter is shown. The number of auxiliary power modules with a multi-resonance circuit for a separate phase is as high as two, in accordance with the number of equivalent half-bridge diagrams, the operation of the three-level system being reduced to that of the last. The mild commutation in this converter resides in the fact that the positive and negative power terminals of the modules are connected respectively to the positive and negative poles of the constant voltage supplies in the converter, the function of which is provided by the capacitors of the input filters in the inverter, and the output power terminals of the modules are connected to a pole of an alternating current power supply in the converter, the function of which is provided by the phase current of the inverter.

Let's examine an example of an embodiment of the device according to the present invention.

The device according to the present invention was built and used for a three-phase voltage inverter.

The power supply voltage E=500 V.

The load current J=40 A.

The main switches of the inverter are of PT-IGBT-type, the voltage class is 1200 V, the average collector current is 100 A, the saturation voltage is 2.5 V, the output capacity is 1 nF.

The switches of the power module with a multi-resonance circuit are of PT-IGBT-type, the voltage class is 1200 V, the average collector current is 50 A, the pulsed current of the collector is 400 A, the saturation voltage is 2.0 V, the output capacity is 0.2 nF.

The choke of the series LC-circuit represents an inductance of 2.0 μH.

The capacitor of the series LC-circuit has the capacity 0.5 μF, the voltage is 1000V.

The capacitor 7 has the capacity 8.2 nF, the voltage is 1000 V.

FIG. 10 illustrates an oscillogram for a mild turning on of one of the main switches for such a converter in the application of a power module with a multi-resonance circuit according to the present invention. The main switch is turned on at zero voltage, the energy of dynamic losses at turning on is practically equal to zero.

Vertical Scale:

Voltage (channel 3)—200 V/div.

Current (channel 4)—20 A/div.

Power (channel M)—1000 W/div.

Horizontal Scale:

Time—1 μsec/div.

FIG. 11 illustrates an oscillogram for a mild turning on of one of the main switches in the converter without a capacitor 7 in the device (like in the closest analogous device). The oscillogram shows strong high-frequency noise during the process of the main transistor (the main switch) commutation. This noise is due to a high resonance frequency of oscillations as a result of a relatively low value of the output capacity in the main transistor.

Vertical Scale:

Voltage (channel 3)—200 V/div.

Current (channel 4)—20 A/div.

Power (channel M)—1000 W/div.

Horizontal Scale:

Time—1 μsec/div.

FIG. 12 illustrates an oscillogram for a mild turning on of one of the converter main switches in the application of a power module with a multi-resonance circuit according to the present invention. The main switch is turned off at zero voltage, the energy of dynamic losses at turning off being practically equal to zero.

Vertical Scale:

Voltage (channel 3)—200 V/div.

Current (channel 4)—20 A/div.

Power (channel M)—1000 W/div.

Horizontal Scale:

Time—1 μsec/div.

FIG. 13 illustrates an oscillogram for a mild turning off of one of the converter main switches without a capacitor 7 in the device (like in the closest analogous device). The oscillogram shows strong high-frequency noise during the process of the main transistor (the main switch) turning off. This noise is due to a high resonance frequency of oscillations as a result of a relatively low value of the output capacity in the main transistor. The current amplitude in the reverse diode of the switch is increased compared to the oscillogram of FIG. 12.

Vertical Scale:

Voltage (channel 3)—200 V/div.

Current (channel 4)—20 A/div.

Power (channel M)—1000 W/div.

Horizontal Scale:

Time—1 μsec/div.

FIG. 14 illustrates an oscillogram for a mild turning on of the switch 1 in the power module with a multi-resonance circuit according to the present invention. The first switch 1 is turned on and off at zero current, the energy of dynamic losses at commutation being practically equal to zero.

Vertical Scale:

Voltage (channel 3)—200 V/div.

Current (channel 4)—50 A/div.

Power (channel M)—1000 W/div.

Horizontal Scale:

Time—1 μsec/div.

FIG. 15 illustrates an oscillogram for a mild commutation of the second switch 2 in the power module with a multi-resonance circuit according to the present invention. The second switch 2 is turned on and off at zero current, the energy of dynamic losses being practically equal to zero.

Vertical Scale:

Voltage (channel 3)—200 V/div.

Current (channel 4)—50 A/div.

Power (channel M)—1000 W/div.

Horizontal Scale:

Time—2 μsec/div.

1. A power module comprising the first and the second switches each one of them having a similar antiparallel diode, and a series LC-circuit, the terminal of the first switch joined to the cathode of the first antiparallel diode being connected to the positive power terminal of the module, and the terminal of the second switch joined to the anode of the second antiparallel diode being connected to the negative power terminal of the module, the first output of the series LC-circuit being connected to the point of juncture of the first and the second switches, the second output of which being connected to the output power terminal of the module, wherein a capacitor is inserted, the first and the second plates of which are connected respectively to the output power terminal of the module and to the positive power terminal of the module.

2. A power module comprising the first and the second switches each one of them having a similar antiparallel diode, and a series LC-circuit, the terminal of the first switch joined to the cathode of the first antiparallel diode being connected to the positive power terminal of the module, and the terminal of the second switch joined to the anode of the second antiparallel diode being connected to the negative power terminal of the module, the first output of the series LC-circuit being connected to the point of juncture of the first and the second switches, the second output of which being connected to the output power terminal of the module, wherein a capacitor is inserted, the first and the second plates of which are connected respectively to the output power terminal of the module and to the negative power terminal of the module.
